(19) United States
(12) Patent Application Publication
(10) Pub. No.: US 2017/0022686 A1
(43) Pub. Date: Jan. 26, 2017

(54) SYSTEM PROVIDING LOAD-BASED AUTOMATED TOOL CONTROL

(71) Applicant: CATERPILLAR INC., Peoria, IL (US)

(72) Inventors: Todd Rowland FARMER, Apex, NC (US); Joshua David CALLAWAY, Cary, NC (US)

(73) Assignee: CATERPILLAR INC., Peoria, IL (US)

(21) Appl. No.: 14/807,101

(22) Filed: Jul. 23, 2015

(51) Int. Cl. E02F 9/20; G07C 5/02

(52) U.S. Cl. CPC E02F 9/2029; G07C 5/02; E02F 9/2079; E02F 9/202

(57) ABSTRACT

A control system is disclosed for a machine having a work tool and a traction device. The control system may have an actuator configured to adjust a depth of the work tool relative to a ground surface, a tool sensor configured to generate a first signal indicative of a performance parameter of the work tool, a speed sensor configured to generate a second signal indicative of an actual speed of the traction device, and a controller in communication with the actuator, the tool sensor, and the speed sensor. The controller may be configured to determine that the work tool is engaged with the ground surface and, when the work tool is determined to be engaged with the ground surface, to make a comparison of the actual speed of the traction device with a rotational speed threshold. The controller may then be configured to selectively cause the actuator to adjust the depth of the work tool based on the comparison.

### TECHNICAL FIELD

The present disclosure is directed to a control system and, more particularly, to a system that provides load-based automated tool control.

### BACKGROUND

Mobile machines such as dozers, scrapers, motor-graders, and wheel loaders often include one or more material engaging implements utilized to dig into, scrape, scoop, or otherwise push against a ground surface. The ground surface can include non-homogenous loose soil or compacted material that can be easy or difficult for a machine to process. As a machine traverses a site that has changing terrain and/or varying ground surface conditions, the magnitude of resistance applied by the material to the implements and to traction devices of the machine also varies. If not accounted for properly by an operator of the machine, the machine can quickly be overloaded or underloaded.

When a machine is overloaded, the traction devices of the machine can be caused to slip (i.e., to spin faster than a travel speed of the machine), thereby reducing a forward momentum of the machine and possibly damaging the machine. The loss in momentum can result in lost productivity and/or efficiency. When the machine is underloaded, although the traction devices may not slip, the machine will still lose productivity and efficiency due to a reduced volume of material being moved. In order to help ensure that high productivity and efficiency of the machine are attained without damaging the machine, the operator of the machine must continuously alter settings of the machine and implement to accommodate the changing terrain and ground surface conditions. This continuous altering can be tiring for even a skilled operator and difficult, if not impossible, for a novice operator to achieve optimally.

One attempt to improve machine efficiency and productivity is disclosed in U.S. Pat. No. 8,726,543 of Kelly that issued on May 20, 2014 (“the '543 patent”). In particular, the '543 patent discloses an excavation machine having a blade that is autonomously controlled in order to maximize an amount of earth moved by the machine. Specifically, a controller signals automated height adjustment of the blade so that wheel-slip does not occur or occurs only within a maximum limit. Algorithms of the controller determine wheel-slip from a comparison of changes in GPS position that are less than a maximum distance expected from measured wheel rotation. When wheel-slip occurs, the controller redirects electro-hydraulic cylinders to raise the blade by a programmed increment. If the controller determines that additional work can be accomplished by the machine's engine within an optimized performance range, and that wheel-slip is not occurring, then the controller may direct the blade to be lowered by a programmed increment to increase the volume of earth being moved.

Although the system of the '543 patent may improve machine efficiencies and productivity by limiting wheel slip through blade height adjustment, the system may be complex and expensive. In particular, the controller may require complex algorithms in order to interface with GPS receivers and process the associated data. In addition, the GPS receivers can be cost-prohibitive in some applications.

The disclosed control system is directed to overcoming one or more of the problems set forth above and/or other problems of the prior art.

### SUMMARY

One aspect of the present disclosure is directed to a control system for a machine having a work tool and a traction device. The control system may include an actuator configured to adjust a depth of the work tool relative to a ground surface, a tool sensor configured to generate a first signal indicative of a performance parameter of the work tool, a speed sensor configured to generate a second signal indicative of an actual speed of the traction device, and a controller in communication with the actuator, the tool sensor, and the speed sensor. The controller may be configured to determine whether the work tool is engaged with the ground surface and, when the work tool is determined to be engaged with the ground surface, to make a comparison of the actual speed of the traction device with a rotational speed threshold. The controller may then be configured to selectively cause the actuator to adjust the depth of the work tool based on the comparison.

Another aspect of the present disclosure is directed to a method of controlling a machine having a work tool and a traction device. The method may include sensing a performance parameter of the work tool, sensing an actual speed of the traction device, and determining that the work tool is engaged with a ground surface. When the work tool is determined to be engaged with the ground surface, the method may also include making a comparison of the actual speed of the traction device with a rotational speed threshold, and selectively adjusting a depth of the work tool relative the ground surface based on the comparison.

Another aspect of the present disclosure is directed to a machine. The machine may include a frame, a work tool, and lift arms pivotally connected at a first end to the frame and at a second end to the work tool. The machine may also include a lift cylinder connected between the frame and the lift arms, at least one lift valve configured to regulate fluid flow through the lift cylinder, and a pressure sensor associated with the lift cylinder and configured to generate a first signal indicative of a current load on the work tool. The machine may further include a traction device connected to the frame and configured to propel the machine, a speed sensor configured to generate a second signal indicative of a speed of the traction device, and a powertrain supported by the frame and operable to power the lift cylinder and the traction device. The machine may additionally include a controller in communication with the at least one lift valve, the pressure sensor, and the speed sensor. The controller may be configured to determine whether the work tool is engaged with the ground surface based on the first signal and, when the work tool is determined to be engaged with the ground surface, to make a comparison of the actual speed of the traction device with a rotational speed threshold at which the traction device is known to slip for the current load. The controller may then be configured to selectively cause the lift cylinder to raise the work tool based on the comparison.

### BRIEF DESCRIPTION OF THE DRAWINGS

FIG. 1 is an isometric illustration of an exemplary disclosed machine;

FIG. 2 is a diagrammatic illustration of an exemplary disclosed control system that may be used in conjunction with the machine of FIG. 1; and

FIGS. 3-5 are flowcharts depicting exemplary disclosed methods that may be performed by the control system of FIG. 2.

### DETAILED DESCRIPTION

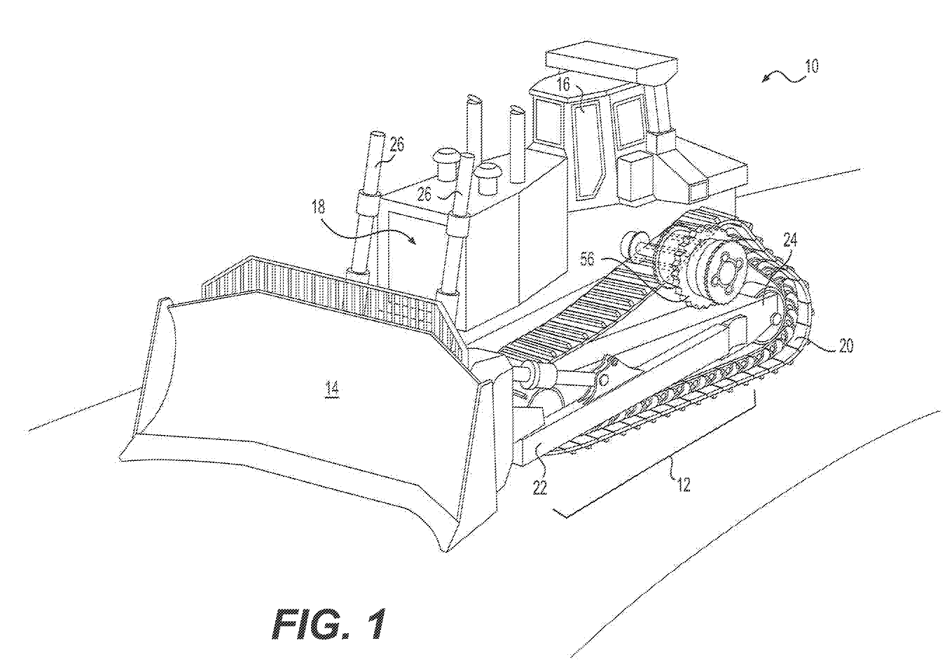

FIG. 1 illustrates an exemplary machine 10 having multiple systems and components that cooperate to move material such as ore, overburden, waste, etc. In the disclosed example, machine 10 is a dozer configured to push material during a dozing operation. It is contemplated, however, that machine 10 could embody another type of machine (e.g., a motor grader, a wheel loader, a skid steer, or a plow) that is configured to grade, scoop, or scrape against the material. Machine 10 may include, among other things, a linkage arrangement 12 configured to move a work tool 14, an operator station 16 for manual control of linkage arrangement 12, and a powertrain 18 that provides electrical, hydraulic, and/or mechanical power to linkage arrangement 12 based on input received via operator station 16. In addition to powering linkage arrangement 12, powertrain 18 may also function to propel machine 10, for example via one or more traction devices (e.g., wheels or tracks) 20.

Linkage arrangement 12 may include fluid actuators that exert forces on structural components of machine 10 to cause lifting movements of work tool 14. Specifically, linkage arrangement 12 may include, among other things, a pair of spaced apart lift arms 22. Lift arms 22 may be pivotally connected at a proximal end to a frame 24 of machine 10 and at a distal end to work tool 14. One or more lift cylinders 26 may be pivotally connected at a first end to frame 24 and at an opposing second end to work tool 14 or to lift arms 22. With this arrangement, extensions and retractions of lift cylinders 26 may function to raise and lower lift arms 22, respectively, along with connected work tool 14. It is contemplated that machine 10 could have another linkage arrangement, if desired.

Numerous different work tools 14 may be attachable to a single machine 10 and controllable via operator station 16. Work tool 14 may include any device used to perform a particular task such as, for example, a blade (shown in FIG. 1), a plow, a bucket, or any other task-performing device known in the art. Although connected in the embodiment of FIG. 1 to lift relative to machine 10, work tool 14 may additionally tilt, rotate, swing, slide, extend, open and close, or move in another manner known in the art.

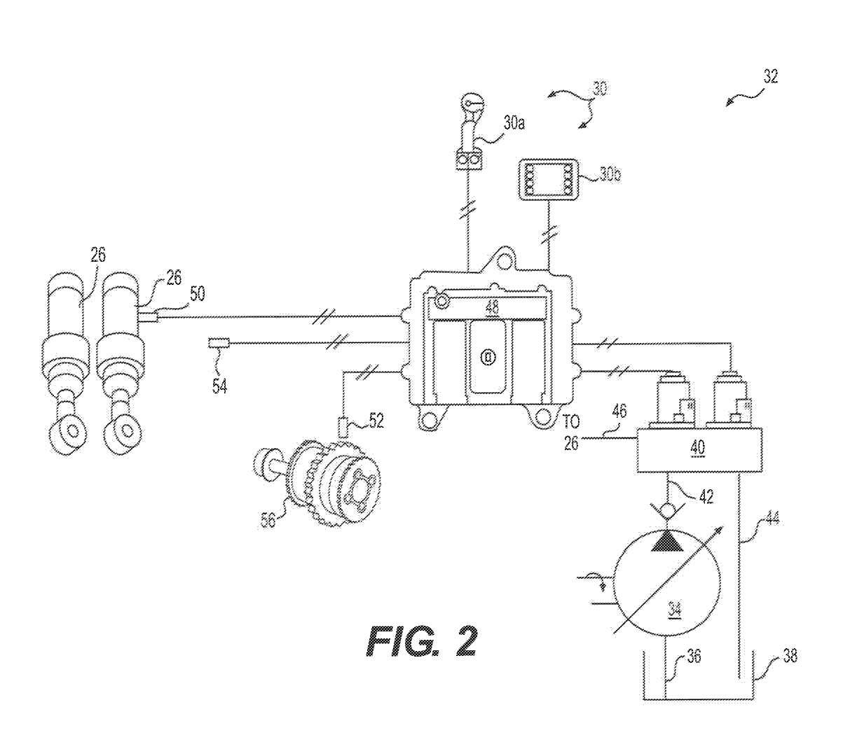

Operator station 16 may be configured to receive input from a machine operator indicative of a desired work tool and/or machine movement. Specifically, operator station 16 may include one or more input devices 30 (e.g., a first input device 30a and a second input device 30b—shown only in FIG. 2) located proximal an operator seat (not shown). Input device 30a may be a proportional-type controller configured to position and/or orient work tool 14, to cause acceleration of machine 10, and/or to brake machine 10 by producing signals that are indicative of desired speeds and/or forces in particular directions. The position signals may be used to actuate any one or more of lift cylinders 26 and powertrain 18. Input device 30b may be, for example, a display or touchscreen monitor having input-receiving capabilities. The input received via input device 30b may include, for example, a desired or maximum travel speed of machine 10, and desired activation of a particular autonomous control algorithm (e.g., a traction control algorithm, an auto-grade algorithm, an auto-load algorithm, etc.). It is contemplated that different input devices 30 may additionally or alternatively be included within operator station 16 such as, for example, wheels, knobs, push-pull devices, switches, pedals, and other operator input devices known in the art. It is contemplated that operator station 16 could be omitted in applications where machine 10 is remotely or autonomously controlled, if desired.

Powertrain 18 may be supported by frame 24 of machine 10 and configured to generate the electrical, hydraulic, and/or mechanical power discussed above. Powertrain 18 may include any combination of an engine (e.g., a diesel engine), a torque converter (not shown), a transmission (e.g., a mechanical step-change, continuously variable, or hybrid transmission—not shown), a differential (not shown), one or more motors (e.g., electric or hydraulic motors—not shown), axles (not shown), a final drive (not shown), and/or any other known component that functions to transmit a torque through traction devices 20. When powertrain 18 is engaged, traction devices 20 may exert a torque on a ground surface below machine 10 that propels machine 10. Powertrain 18 may be manually and/or electronically controlled to drive traction devices 20 at the desired speed and/or up to the maximum speed selected via input device 30b. The engine of powertrain 18 may additionally drive lift cylinders 26 to move work tool 14 in accordance with manual and/or autonomous commands.

Lift cylinders 26 may each be a linear type of actuator consisting of a tube, and a piston assembly arranged within the tube to form opposing control chambers. The control chambers may each be selectively supplied with pressurized fluid and drained of the pressurized fluid to cause the piston assembly to displace within the tube, thereby changing an effective length of lift cylinders 26 and moving work tool 14. A flow rate of fluid into and out of the control chambers may relate to a translational speed of lift cylinders 26, while a pressure differential between the control chambers may relate to a force imparted by lift cylinders 26 on the associated structure of linkage arrangement 12. It is contemplated that lift cylinders 26 could be replaced with another type of actuator (e.g., a rotary actuator), if desired.

As illustrated in FIG. 2, lift cylinders 26 and input devices 30 may form portions of a control system (“system”) 32. System 32 may include one or more fluid circuits that distribute pressurized oil used to drive lift cylinders 26 in response to received input. In particular, system 32 may include, among other things, a common pump 34 connected via a suction passage 36 to a common low-pressure reservoir 38, and one or more lift control valves 40. Pump 34 may be configured to draw fluid from reservoir 38 via suction passage 36 and to pressurize the fluid. Valve 40 may be connected to pump 34 via a supply passage 42 to receive the pressurized fluid, and also to reservoir 38 via a drain passage 44. In addition, valve 40 may be connected to lift cylinders 26 via one or more conduits 46. Control valve 40 may be responsible for connecting supply passage 42 and drain passage 44 to particular control chambers inside lift cylinders 26 to cause commanded extensions or retractions between opposing end-of-stroke (i.e., maximum and minimum) displacement positions.

In manually controlled applications, the commands to extend or retract lift cylinders 26 may be generated via input device 30a and processed by an onboard controller 48. That is, controller 48 may receive the input from operator via device 30a, and convert the input into electronic commands directed to valve 40. In remotely or autonomously controlled applications, however, the electronic commands may be directly generated by on-board controller 48 or by another off-board controller (not shown) that is in remote communication with on-board controller 48. Regardless of the application, controller 48 may additionally be configured to monitor the performance of lift cylinders 26 during commanded operations. For example, system 32 may include one or more sensors (e.g., a pressure sensor 50, a speed sensor 52, and an accelerometer 54) configured to provide feedback to controller 48 regarding commanded movements. Controller 48 may then selectively adjust lift cylinder operation based on the feedback.

Controller 48 may embody a single microprocessor or multiple microprocessors that include a means for monitoring operations of machine 10. For example, controller 48 may include a memory, a secondary storage device, a clock, and a processor, such as a central processing unit or any other means for accomplishing a task consistent with the present disclosure. Numerous commercially available microprocessors can be configured to perform the functions of controller 48. It should be appreciated that controller 48 could readily embody a general machine controller capable of controlling numerous other machine functions. Various other known circuits may be associated with controller 48, including signal-conditioning circuitry, communication circuitry, and other appropriate circuitry.

Pressure sensor 50 may be associated with one or both of lift cylinders 26, and configured to generate signals indicative of a pressure of fluid therein. In one embodiment, sensor 50 is associated with one of the pressure chambers (e.g., the rod-end pressure chamber) inside one of lift cylinders 26. In another embodiment, pressure sensor 50 is associated with supply passage 42 that leads to both of lift cylinders 26 (and, in some embodiments, to other actuators of machine 10). In either embodiment, signals from pressure sensor 50 may be directed to controller 48 for use in regulating operation of valve 40.

Speed sensor 52 may embody a conventional rotational speed detector having a stationary element rigidly connected to frame 24 (referring to FIG. 1) that is configured to sense a relative rotational movement of traction device 20 (e.g., of a rotating portion 56 of powertrain 18 that is operatively connected to traction device 20, such as an axle, a gear, a cam, a hub, a final drive, etc.). In the depicted example, the stationary element is a magnetic or optical element mounted to an axle housing (e.g., to an internal surface of the housing) and configured to detect the rotation of an indexing element (e.g., a toothed tone wheel, an imbedded magnet, a calibration stripe, teeth of a timing gear, a cam lobe, etc.) connected to rotate with traction device 20. In this example, the indexing element could be connected to, embedded within, or otherwise form a portion of the axle assembly that is driven to rotate by powertrain 18. Sensor 52 may be located adjacent the indexing element and configured to generate a signal each time the indexing element (or a portion thereof, for example a tooth) passes near the stationary element. This signal may be directed to controller 48, and controller 48 may use this signal to determine a rotational speed and/or acceleration of traction device 20. Other types of speed sensors may also or alternatively be employed.

Accelerometer 54 may embody a conventional acceleration detector rigidly connected to frame 24 in an orientation that allows sensing of fore/aft changes in speed of machine 10. It is contemplated that accelerometer 54 may include additional acceleration detectors (e.g., accelerometer 54 could embody a 3-way detector), if desired, to sense changes in speed of machine 10 in additional directions. Signals generated by accelerometer 54 may be directed to controller 48 for further processing.

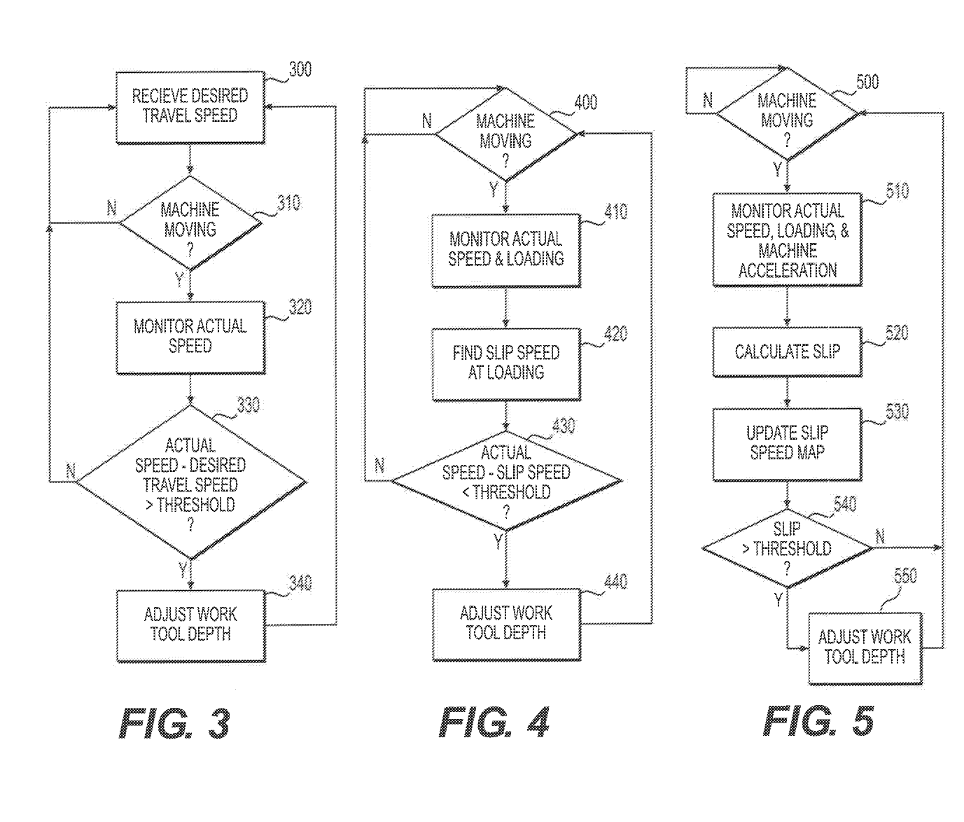

FIGS. 3-5 illustrate exemplary tool load control processes, wherein controller 48 assumes autonomous control over lift cylinders 26 while attempting to maintain productive forward movement of machine 10. FIGS. 3-5 will be discussed in more detail in the following section to further illustrate the disclosed concepts.

### INDUSTRIAL APPLICABILITY

The disclosed control system finds potential application within any machine at any worksite where it is desirable to provide tool loading assistance and/or automated control. The control system finds particular application within a dozer, motor-grader, wheel loader, or skid-steer that has one or more lift cylinders that raise and lower a work tool (particularly a blade or bucket). The control system may help to load the work tool in a productive and efficient manner, while avoiding excessive slipping of an associated traction device. Operation of system 32 will now be described in detail with reference to FIGS. 3-5.

During operation of machine 10, the loading of work tool 14 may affect forward momentum of machine 10 and/or operation of traction devices 20. For example, as work tool 14 is more heavily loaded, machine 10 may slow down due to an increasing resistance to forward travel. At this same time, a torque output of traction devices 20 may increase by an amount proportional to the loading. At some point, the loading could reach a point at which forward travel of machine 10 slows or stops, and traction devices 20 spin inefficiently (i.e., rotate at a speed much slower than a travel speed of machine 10). Controller 48 may be configured to selectively adjust loading of work tool 14 (e.g., by raising or lowering work tool 14 into the ground surface) to increase productivity and efficiency. Controller 48 may do this in several different ways, depending on how machine 10 is equipped.

In a first example shown in FIG. 3, machine 10 may be provided with speed sensor 52, but not with pressure sensor 50 or accelerometer 54. The process of FIG. 3 may begin with controller 48 receiving a desired travel speed of machine 10 (Step 300). As described above, the desired travel speed may be received via input device 30b. Controller 48 may then check to see if machine 10 is moving (Step 310). The movement of machine 10 may be checked via speed sensor 52. In some embodiments, the travel direction may also be checked by controller 48 in step 310, if desired. Until machine 10 begins traveling (and traveling in a particular direction, for example forward), control may cycle back to step 300.

When controller 48 determines at step 310 that machine 10 is traveling (and traveling in a forward direction) (step 310: Y), controller 48 may begin monitoring an actual speed of traction device 20 (Step 320). Controller 48 may determine a difference between the actual speed and the desired travel speed, and compare the difference to a speed threshold (Step 330). When loading of work tool 14 is an appropriate amount, the actual speed should be relatively close to the desired travel speed (e.g., within about 10-15%). However, as loading of work tool 14 becomes excessive, the actual speed may fall away from the desired travel speed by a greater amount. Therefore, as long as the difference between the actual speed and the desired travel speed remains less than the threshold speed (step 330: N), control may cycle back to step 300.

However, when controller 48 determines at step 330 that the actual speed has fallen away from the desired travel speed by an amount greater than the threshold speed (step 330: Y), controller 48 may determine that the load on work tool 14 is too great and responsively adjust a depth of work tool 14 (Step 340). That is, controller 48 may raise work tool 14 out of the ground surface to thereby lower the load on work tool 14. By lowering the load on work tool 14, controller 48 may cause machine 10 to increase in speed back up toward the desired travel speed. It is contemplated that controller 48 may likewise lower work tool 14 further into the ground surface, if desired, to increase loading of work tool 14 when the actual speed becomes too close to (or greater than) the desired travel speed. It should be noted that the lowering of work tool 14 into the ground surface may be limited in some applications by other autonomous algorithms (e.g., by slope control or auto-grading algorithms). Control may return from step 340 to step 300.

When machine 10 is provided with pressure sensor 50, additional functionality may be realized. In particular, as shown in FIG. 4, controller 48 may be configured to selectively adjust the depth of work tool 14 up to a slip-threshold, which in some cases may allow greater productivity when compared to the process of FIG. 3. The process of FIG. 4 may begin with controller 48 determining if machine 10 is moving (Step 400). This step may be substantially identical to step 310 of FIG. 3, which is already described above. Until machine 10 begins movement, control may cycle through step 400.

When controller 48 determines at step 400 that machine 10 is traveling (and traveling in a forward direction) (step 400: Y), controller 48 may begin monitoring the actual speed of traction device 20 and loading of work tool 14 (Step 410). As described above, controller 48 may monitor the actual speed via speed sensor 52 and the loading via pressure sensor 50. Controller 48 may then find a slip speed for machine 10 corresponding to the given loading (Step 420). The slip speed may be a speed found from past experience at which traction devices 20 begin to slip or to slip by an unacceptable amount when work tool 14 is pushing a known load. In some embodiments, the slip speed may be related to loading in an electronic map stored in the memory of controller 48. In these embodiments, controller 48 may find the slip speed by referencing the loading of work tool 14 with the map. In other embodiments, however, controller 48 may be able to find the slip speed for the given loading in other ways (e.g., via an equation).

After completion of step 420, controller 48 may then compare a difference between the actual speed and the slip speed with a threshold speed (Step 430). As long as the difference between the actual and slip speeds remains greater than the threshold speed (step 430: N), control may cycle back to step 400.

However, when controller 48 determines at step 430 that the actual speed is nearing (e.g., slowing down to) the slip speed (i.e., is within the threshold amount of the threshold speed—step 430: Y), controller 48 may adjust the depth of work tool 14 (Step 440). That is, controller 48 may raise work tool 14 out of the ground surface to thereby lower the load on work tool 14. By lowering the load on work tool 14, controller 48 may cause machine 10 to increase in speed away from the slip speed. It is contemplated that controller 48 may likewise lower work tool 14 further into the ground surface, if desired, to increase loading of work tool 14 when the actual speed becomes too far away from the slip speed. As described above, the lowering of work tool 14 into the ground surface may be limited in some applications by other autonomous algorithms (e.g., by slope control or auto-grading algorithms). Control may return from step 440 to step 400.

When machine 10 is provided with both pressure sensor 50 and accelerometer 54, additional functionality may be realized. In particular, as shown in FIG. 5, controller 48 may be configured to selectively update the slip speed map stored in memory based on monitored conditions. By updating the slip speed map to account for current ground conditions, an accuracy of the load control process may be enhanced, when compared to the processes of FIGS. 3 and 4. The process of FIG. 5 may begin with controller 48 determining if machine 10 is moving (Step 500). This step may be substantially identical to steps 310 of FIG. 3 and 400 of FIG. 4, which are both already described above. Until machine 10 begins movement, control may cycle through step 500.

When controller 48 determines at step 500 that machine 10 is traveling (and traveling in a forward direction) (step 500: Y), controller 48 may begin monitoring the actual speed of machine 10, loading of work tool 14, and an acceleration of machine 10 (Step 510). As described above, controller 48 may monitor the actual speed via speed sensor 52 and the loading via pressure sensor 50. Controller 48 may monitor the acceleration of machine 10 via accelerometer 54. Controller 48 may then calculate an amount of slip currently being experienced by traction devices 20 (Step 520). The slip may be calculated by comparing a change in the actual speed of traction devices 20 with the acceleration sensed by accelerometer 54. A difference in these values may indicate a change in traction device speed that did not translate into an acceleration of machine 10, which can be indicative of the slip condition. After calculating the amount of slip currently being experienced by traction devices 20 under the given loading conditions, controller 48 may update the slip speed map stored in memory (Step 530). This map may then be used by other similar machines that do not have an accelerometer and/or by the same machine 10 in situations where accelerometer 54 is malfunctioning and/or unreliable by following the process of FIG. 4.

At any time after completion of step 520 (e.g., subsequent to or simultaneously with step 530), controller 48 may make a comparison of the amount of slip currently being experienced by traction devices 20 with a slip threshold (Step 540). When the amount of slip currently being experienced by traction devices 20 is less than the slip threshold (step 530: N), controller 48 control may return from step 540 to step 500. In some embodiments, however, controller 48 may adjust (i.e., increase) the depth of work tool 14 until the amount of slip is within a desired range of the slip threshold, such that some slip is being experienced by traction devices 20 (i.e., an amount that is less than the slip threshold), before returning to step 500. When the amount of slip currently being experienced by traction devices 20 is more than the slip threshold, controller 48 may decrease the depth of work tool 14 (Step 550), before returning control to step 500.

The disclosed system may provide a way to improve machine productivity and efficiency in a simple and low-cost manner. In particular, because the disclosed system may not need to rely on GPS receivers to determine work tool loading or to detect slip conditions, the system may be inexpensive and require uncomplicated computing algorithms.

It will be apparent to those skilled in the art that various modifications and variations can be made to the control system of the present disclosure. Other embodiments will be apparent to those skilled in the art from consideration of the specification and practice of the control system disclosed herein. It is intended that the specification and examples be considered as exemplary only, with a true scope being indicated by the following claims and their equivalents.

What is claimed is:

1. A control system for a machine having a work tool and a traction device, the control system comprising:
an actuator configured to adjust a depth of the work tool relative to a ground surface;
a tool sensor configured to generate a first signal indicative of a performance parameter of the work tool;
a speed sensor configured to generate a second signal indicative of an actual speed of the traction device; and
a controller in communication with the actuator, the tool sensor, and the speed sensor, the controller being configured to:
determine whether the work tool is engaged with the ground surface;
when the work tool is determined to be engaged with the ground surface, make a comparison of the actual speed of the traction device with a rotational speed threshold; and
selectively cause the actuator to adjust the depth of the work tool based on the comparison.

2. The control system of claim 1, wherein:
the tool sensor is a pressure sensor associated with the actuator;
the performance parameter is a load on the work tool; and
the controller is configured to determine that the work tool is engaged with the ground surface based on the load.

3. The control system of claim 2, wherein:
the controller is further configured to receive a desired speed;
the comparison is a comparison of a difference between the actual and desired speeds to the rotational speed threshold; and
the controller is configured to selectively cause the actuator to raise the work tool when the difference is greater than the rotational speed threshold.

4. The control system of claim 3, wherein the controller is configured to:
selectively cause the actuator to raise the work tool at a first speed when the difference is a first amount greater than the rotational speed threshold; and
selectively cause the actuator to raise the work tool at a second speed faster than the first speed when the difference is a second amount greater than the first amount.

5. The control system of claim 1, wherein the rotational speed threshold is a threshold associated with a rotational speed at which the traction device is known to slip.

6. The control system of claim 5, wherein the controller is configured to determine the rotational speed threshold based on the first signal.

7. The control system of claim 6, wherein:
the tool sensor is a pressure sensor associated with the actuator;
the performance parameter is a load on the work tool; and
the controller is configured to determine the rotational speed threshold by reference of the first and second signals with a map stored in a memory of the controller.

8. The control system of claim 7, further including an accelerometer configured to generate a third signal indicative of an acceleration of the machine, wherein the controller is further configured to:
detect slip of the traction device based the second and third signals; and
selectively update the map based on detected slip.

9. A method of controlling a machine having a work tool and a traction device, the method comprising:
sensing a performance parameter of the work tool;
sensing an actual speed of the traction device;
determining whether the work tool is engaged with a ground surface;
when the work tool is determined to be engaged with the ground surface, making a comparison of the actual speed of the traction device with a rotational speed threshold; and
selectively adjusting a depth of the work tool relative to the ground surface based on the comparison.

10. The method of claim 9, wherein:
determining that the work tool is engaged with the ground surface includes determining that the work tool is engaged with the ground surface based on the performance parameter; and
sensing the performance parameter includes sensing a pressure of an actuator used to lift the work tool, the pressure being indicative of a load on the work tool.

11. The method of claim 10, further including:
receiving a desired speed; and
the comparison is a comparison of a difference between the actual and desired speeds to the rotational speed threshold.

12. The method of claim 11, wherein selectively adjusting the depth of the work tool includes selectively raising the work tool when the difference is greater than the rotational speed threshold.

13. The method of claim 12, wherein selectively raising the work tool includes:
selectively raising the work tool at a first speed when the difference is a first amount greater than the rotational speed threshold; and
selectively raising the work tool at a second speed faster than the first speed when the difference is a second amount greater than the first amount.

14. The method of claim 9, wherein the rotational speed threshold is a threshold at which the traction device is known to slip.

15. The method of claim 14, further including determining the rotational speed threshold based on the performance parameter.

16. The method of claim 15, wherein:
sensing the performance parameter includes sensing a pressure of an actuator used to lift the work tool, the pressure being indicative of a load on the work tool; and
the method further includes determining the rotational speed threshold by reference of the load and the actual speed with an electronic map.

17. The method of claim 16, further including:
sensing an acceleration of the machine;
detecting slip of the traction device based on a change in the actual speed and the acceleration; and
selectively updating the electronic map based on detected slip.

18. A machine, comprising:
a frame;
a work tool;
lift arms pivotally connected at a first end to the frame and at a second end to the work tool;
a lift cylinder connected between the frame and the lift arms;
at least one lift valve configured to regulate fluid flow through the lift cylinder;
a pressure sensor associated with the lift cylinder and configured to generate a first signal indicative of a load on the work tool;
a traction device connected to the frame and configured to propel the machine;
a speed sensor configured to generate a second signal indicative of an actual speed of the traction device; and
a controller in communication with the at least one lift valve, the pressure sensor, and the speed sensor, the controller being configured to:
determine whether the work tool is engaged with the ground surface based on the first signal;
when the work tool is determined to be engaged with the ground surface, make a comparison of the actual speed of the traction device with a rotational speed threshold at which the traction device is known to slip for the load; and
selectively cause the lift cylinder to raise the work tool based on the comparison.

19. The machine of claim 18, wherein:
the first signal is indicative of a fluid pressure inside a rod-end chamber of the lift cylinder;
the machine further includes a powertrain supported by the frame and configured to drive the traction device and the lift cylinder; and
the second signal is indicative of a frequency of a rotating portion of the powertrain that is operatively connected to the traction device.

20. The machine of claim 18, further including an accelerometer operatively mounted to the frame and configured to generate a third signal indicative of an acceleration of the machine in a fore/aft direction, wherein the controller is in further communication with the accelerometer and configured to:
determine the rotational speed threshold by reference of the first and second signals with a map stored in a memory of the controller;
detect slip of the traction device based the second and third signals; and
selectively update the map based on detected slip.
